(19) United States
(12) Patent Application Publication
(10) Pub. No.: US 2008/0231551 A1
(43) Pub. Date: Sep. 25, 2008

(54) Discharge Display Device

(75) Inventors: Tomoyuki Nukumizu, Tokyo (JP); Tadayoshi Kosaka, Tokyo (JP); Kazushige Takagi, Tokyo (JP); Yoshiho Seo, Tokyo (JP); Hajime Inoue, Tokyo (JP); Koichi Sakita, Tokyo (JP)

Correspondence Address: MCDERMOTT WILL & EMERY LLP, 600 13TH STREET, N.W., WASHINGTON, DC, 20005-3096, US

(73) Assignee: HITACHI PLASMA PATNET LICENSING CO.,, TOKYO (JP)

(21) Appl. No.: 11/886,866

(22) PCT Filed: Mar. 22, 2005
(86) PCT No.: PCT/JP2005/005156

§ 371 Date: May 20, 2008

(51) Int. Cl. G09G 3/28; H01J 1/62

(52) U.S. Cl. 345/60; 313/509

(57) ABSTRACT

On a front substrate, a dielectric layer for accumulating the wall charge is formed, and inside the dielectric layer, a first electrode and a second electrode intersecting each other are formed with a predetermined pitch. The dielectric layer is not flat but is convex at the intersection of the first electrode and the second electrode, and the thickness in the direction of the discharge space from the second electrode at the intersection is larger than the thickness in the remaining area. Consequently, since the electric field distribution at the intersection is coarser than that at places apart from the intersection when discharge is sustained by causing an electric field distribution in the discharge space through the dielectric layer, discharge occurs not at the intersection but in four positions at places apart from the intersection, so that the luminous efficiency per discharge cell is improved.

### TECHNICAL FIELD

The present invention relates to discharge display devices, and more specifically, to a discharge display device capable of improving the luminous efficiency by controlling the position where discharge occurs in the discharge space.

### BACKGROUND ART

FIG. 15 is a perspective view of the essential part of a conventional discharge display device (two-orthogonal-electrode discharge PDP). FIG. 16 is a schematic plan view. FIG. 17 is a structural sectional view taken along line XVII-XVII of FIG. 16.

Two-orthogonal-electrode discharge PDPs as discharge display devices are self-luminous display devices in which a front substrate 100a and a rear substrate 100b such as glass plates excellent in the transmittance in the visible region (380 nm to 770 nm) are disposed opposite to each other and a discharge medium such as Xe—Ne or Xe—He is sealed in a space formed by sealing the peripheries of the opposing surfaces of the front substrate 100a and the rear substrate 100b with a sealer.

On the front substrate 100a, a dielectric layer 101 for accumulating the wall charge is formed, and inside the dielectric layer 101, a first electrode 103 and a second electrode 104 orthogonal to each other are formed with a predetermined pitch. Discharge cells are formed with the intersections of the first electrode 103 and the second electrode 104 at the center. On the rear substrate 100b, a grid-shaped partition 106 demarcating the discharge cells with the intersections of the first electrode 103 and the second electrode 104 at the center is formed, and on the side surface of the partition 106 and on the rear substrate 100b (on the bottom surface of the groove formed by the partition), fluorescent layers 107 of three colors of red, green and blue for color display are cyclically formed.

A voltage is applied between the first electrode 103 and the second electrode 104 to thereby selectively cause the address discharge for display writing. Then, a pulse voltage is applied between the first electrode 103 and the second electrode 104 to thereby accumulate the wall charge on the surface of the dielectric layer 101, an electric field is caused in the discharge space by the wall charge, and a sustaining discharge is caused in the discharge cell where the address discharge is caused. The sustaining discharge is such that discharge is continuously caused by repeating the following: After addressing is performed, the voltage applied between the first electrode 103 and the second electrode 104 is switched and discharge is caused in the discharge space through the dielectric layer 101, and the voltage applied between the first electrode 103 and the second electrode 104 is further switched and discharge is newly caused. This discharge causes a collision with Xe in the discharge medium, whereby vacuum ultra-violet light is emitted. The emitted vacuum ultra-violet light excites the fluorescent layers 107, whereby visible light is emitted. As described above, this structure functions as a display device by controlling the electric field in each discharge cell by the voltage applied between the first electrode 103 and the second electrode 104 and controlling the generation of the vacuum ultra-violet light.

In such a display device, it is extremely important to reduce power consumption by improving the luminous efficiency, and technologies for improving the luminous efficiency have been proposed. For example, Patent Document 1 discloses a technology to reduce power consumption by improving the panel luminous efficiency of the PDP by reducing the discharge starting voltage by a structure in which the thickness of the dielectric layer at the discharge gap and a part near the discharge gap is smaller than that of the dielectric layer at the remaining part.

[Patent Document 1] Japanese Patent Application Laid-Open No. 2000-285811

### DISCLOSURE OF THE INVENTION PROBLEMS TO BE SOLVED BY THE INVENTION

However, the technology disclosed in Patent Document 1 is effective when the pair of electrodes causing the electric field necessary for discharge extend parallel to each other and never intersect each other, and cannot be applied to two-orthogonal-electrode discharge PDPs. That is, in two-orthogonal-electrode discharge PDPs, two electrodes are disposed with the dielectric layer between, and as shown in FIG. 18, the electric field is the strongest at the intersection of the two electrodes.

Therefore, as shown in FIG. 19, discharge 150 occurs in one position at the intersection. For this reason, for example, when the size of the discharge cells is increased in order to increase the screen size, since discharge occurs only at the centers of the discharge cells which are the intersections, the brightness as the display device is low, so that the peripheral parts of the discharge cells are slightly dark and the luminous efficiency is poor.

The present invention is made in view of such circumstances, and an object thereof is to provide a discharge display device capable of improving the luminous efficiency per discharge space by causing discharge not at the intersections of the first electrode and the second electrode but at places apart from the intersections when the discharge is sustained by applying a voltage between the first electrode and the second electrode to thereby cause an electric field distribution in the discharge space through the dielectric layer, by providing a structure in which the thickness, on the discharge space side, of the dielectric layer in the area corresponding to the intersection is larger than that in the remaining area.

Another object of the present invention is to provide a discharge display device capable of efficiently emitting light from the discharge space by controlling the position where discharge occurs, by adjusting the thickness of the dielectric layer in the area corresponding to the intersection to thereby adjust the electric field distribution caused in the discharge space.

Another object of the present invention is to provide a discharge display device capable of further controlling the position where discharge occurs by adjusting the electric field distribution caused in the discharge space, by adjusting the area of the dielectric layer in the area corresponding to the intersection to thereby adjust the electric field distribution caused in the discharge space.

Another object of the present invention is to provide a discharge display device capable of efficiently emitting light from the entire discharge space by reliably displacing the discharge position from the intersection by a structure in which the thickness of the dielectric layer in the area corresponding to the intersection is not less than twice that in the remaining area.

### Means for Solving the Problems

In a discharge display device according to a first aspect in which a discharge space is formed by sealing a discharge medium between two substrates, a dielectric layer, and a first electrode and a second electrode intersecting each other are provided, and by applying a voltage between the first electrode and the second electrode, an electric field distribution is caused in the discharge space through the dielectric layer to thereby sustain discharge; the thickness, on the discharge space side, of the dielectric layer in the area corresponding to the intersection of the first electrode and the second electrode is larger than that in the remaining area.

According to the first aspect, the discharge space is formed by sealing the discharge medium between the two substrates, and the thickness, on the discharge space side, of the dielectric layer in the area corresponding to the intersection of the first electrode and the second electrode is larger than that in the remaining area. When discharge is sustained by causing an electric field distribution in the discharge space through the dielectric layer by applying a voltage between the first electrode and the second electrode, since the electric field distribution (electric line of force) at the intersection is coarser than that at places apart from the intersection, discharge occurs not at the intersection but in four positions apart from the intersection. That is, while discharge occurs only in one position at the intersection in the conventional discharge display device, in the present invention, since discharge occurs in four positions, the luminous efficiency per discharge cell is improved.

In a discharge display device according to a second aspect in which a discharge space is formed by sealing a discharge medium between two substrates, a dielectric layer and a first electrode and a second electrode intersecting each other inside the dielectric layer are provided on one of the two substrates, and by applying a voltage between the first electrode and the second electrode, an electric field distribution is caused in the discharge space through the dielectric layer to thereby sustain discharge; the thickness of the dielectric layer in the direction of the discharge space from the discharge space side electrode of the first electrode and the second electrode in the area corresponding to the intersection of the first electrode and the second electrode is larger than that in the remaining area.

According to the second aspect, the discharge space is formed by sealing the discharge medium between the two substrates, the dielectric layer and the first electrode and the second electrode intersecting each other inside the dielectric layer are provided on one substrate. The thickness of the dielectric layer in the direction of the discharge space from the discharge space side electrode of the two electrodes in the area corresponding to the intersection of the first electrode and the second electrode is larger than that in the remaining area. When discharge is sustained by causing an electric field distribution in the discharge space through the dielectric layer by applying a voltage between the first electrode and the second electrode, since the electric field distribution at the intersection is coarser than that at places apart from the intersection, discharge occurs not at the intersection but in four positions apart from the intersection. That is, while discharge occurs only in one position at the intersection in the conventional discharge display device, in the present invention, since discharge occurs in four positions, the luminous efficiency per discharge cell is improved. Moreover, since surface discharge can be caused by providing the pair of electrodes for causing the sustaining discharge on one substrate, for example, when a color display device is formed by providing fluorescent layers in the discharge space, deterioration of the fluorescent layers due to opposite discharge is suppressed by providing the first electrode and the second electrode on a substrate different from the substrate where the fluorescent layers are provided, whereby the occurrence of a color shift of the discharge display device can be prevented.

The opposite discharge between the address electrode and the scan electrode is performed in the address period also in the currently predominant three-electrode surface-discharge plasma displays in which the address period and the display period are separate from each other. In the two-orthogonal-electrode structure, such opposite discharge in the address period can be rendered unnecessary.

In a discharge display device according to a third aspect, in the first aspect or in the second aspect, the electric field distribution caused in the discharge space is adjusted by adjusting the thickness of the dielectric layer in the area corresponding to the intersection.

According to the third aspect, the electric field distribution caused in the discharge space is adjusted by adjusting the thickness of the dielectric layer in the area corresponding to the intersection. By increasing the thickness of the dielectric layer at the intersection, the occurrence of discharge at the intersection is avoided and long-distance discharge is caused in positions apart from the intersection, so that the luminous efficiency per discharge space can be improved. As described above, light can be efficiently emitted from the discharge space by controlling the position where discharge occurs, by adjusting the thickness of the dielectric layer to thereby appropriately adjust the electric field distribution caused in the discharge cells.

In a discharge display device according to a fourth aspect, in the third aspect, the electric field distribution caused in the discharge space is adjusted by adjusting the area of the dielectric layer in the corresponding area.

According to the fourth aspect, the electric field distribution caused in the discharge space is adjusted by adjusting the area of the dielectric layer in the area corresponding to the intersection. By increasing the thickness of the dielectric layer at the intersection and adjusting the area thereof to thereby adjust the electric field distribution caused in the discharge space, the position where discharge occurs can be further controlled.

In a discharge display device according to a fifth aspect, in the third aspect or in the fourth aspect, the thickness of the dielectric layer in the corresponding area is not less than twice that in the remaining area.

According to the fifth aspect, the thickness of the dielectric layer in the area corresponding to the intersection is not less than twice that in the remaining area. Thereby, the discharge position can be displaced from the intersection. Although the discharge voltage is higher than that in the conventional device since the discharge distance between the first electrode and the second electrode is long, by performing long-distance discharge, light can be efficiently emitted from the entire discharge space, so that the luminous efficiency can be improved.

### EFFECTS OF THE INVENTION

According to the present invention, since the thickness, on the discharge space side, of the dielectric layer in the area corresponding to the intersection of the first electrode and the second electrode is larger than that in the remaining area, when discharge is sustained by causing an electric field distribution in the discharge space through the dielectric layer by applying a voltage between the first electrode and the second electrode, since the electric field distribution at the intersection is coarser than that at places apart from the intersection, discharge occurs not at the intersection but at places apart from the intersection. Therefore, for example, when the size of the discharge space is increased, by displacing the position where discharge occurs from the intersection of the electrodes and causing discharge in four positions around the intersection, light can be efficiently emitted from the entire discharge cells, which is effective means for increasing the screen size. Moreover, by causing surface discharge by providing a pair of electrodes for causing the sustaining discharge on one substrate, for example, when a color display device is formed by providing fluorescent layers in the discharge space, deterioration of the fluorescent layers is suppressed by providing the first electrode and the second electrode on a substrate different from the substrate where the fluorescent layers are provided, whereby the occurrence of a color shift of the discharge display device can be prevented.

According to the present invention, by controlling the position where discharge occurs, by adjusting the thickness of the dielectric layer in the area corresponding to the intersection to thereby adjust the electric field distribution caused in the discharge space, light can be efficiently emitted from the discharge space. That is, the occurrence of discharge at the intersection is avoided and long-distance discharge is caused in positions apart from the intersection, so that the luminous efficiency per discharge space can be improved.

According to the present invention, by adjusting the area of the dielectric layer in the area corresponding to the intersection to thereby adjust the electric field distribution caused in the discharge space, the position where discharge occurs can be further controlled by adjusting the electric field distribution caused in the discharge space.

According to the present invention, by providing a structure in which the thickness of the dielectric layer in the area corresponding to the intersection is not less than twice that in the remaining area, the discharge position can be displaced from the intersection. Although the discharge voltage is higher than that in the conventional device since the discharge distance between the first electrode and the second electrode is long, by performing long-distance discharge, light can be efficiently emitted from the entire discharge space, so that the luminous efficiency is improved. Thus, the present invention produces excellent effects.

### BRIEF DESCRIPTION OF THE DRAWINGS

FIG. 1 is a schematic plan view of a discharge display device according to a first embodiment of the present invention;

FIG. 2 is a structural sectional view taken along line II-II of FIG. 1;

FIG. 3 is a structural sectional view taken long line III-III of FIG. 1;

FIG. 4 is sectional views each showing an electric field distribution caused in the discharge space of the discharge display device according to the first embodiment of the present invention;

FIG. 5 is a schematic perspective view showing the electric field distribution caused in the discharge space of the discharge display device according to the first embodiment of the present invention;

FIG. 6 is a schematic perspective view showing the discharge condition of the discharge display device according to the first embodiment of the present invention;

FIG. 7 is explanatory views showing a method for manufacturing a front substrate used for the discharge display device according to the present invention;

FIG. 8 is a structural sectional view of a discharge display device according to a second embodiment of the present invention;

FIG. 9 is a structural sectional view of the discharge display device according to the second embodiment of the present invention;

FIG. 10 is a structural sectional view of a discharge display device according to a third embodiment of the present invention;

FIG. 11 is a structural sectional view of a discharge display device according to a fourth embodiment of the present invention;

FIG. 12 is views showing another example of the configuration of a dielectric according to the present invention;

FIG. 13 is views showing another example of the configuration of the dielectric according to the present invention;

FIG. 14 is a schematic plan view showing another example of the discharge display device according to the present invention;

FIG. 15 is a perspective view of the essential part of the conventional discharge display device;

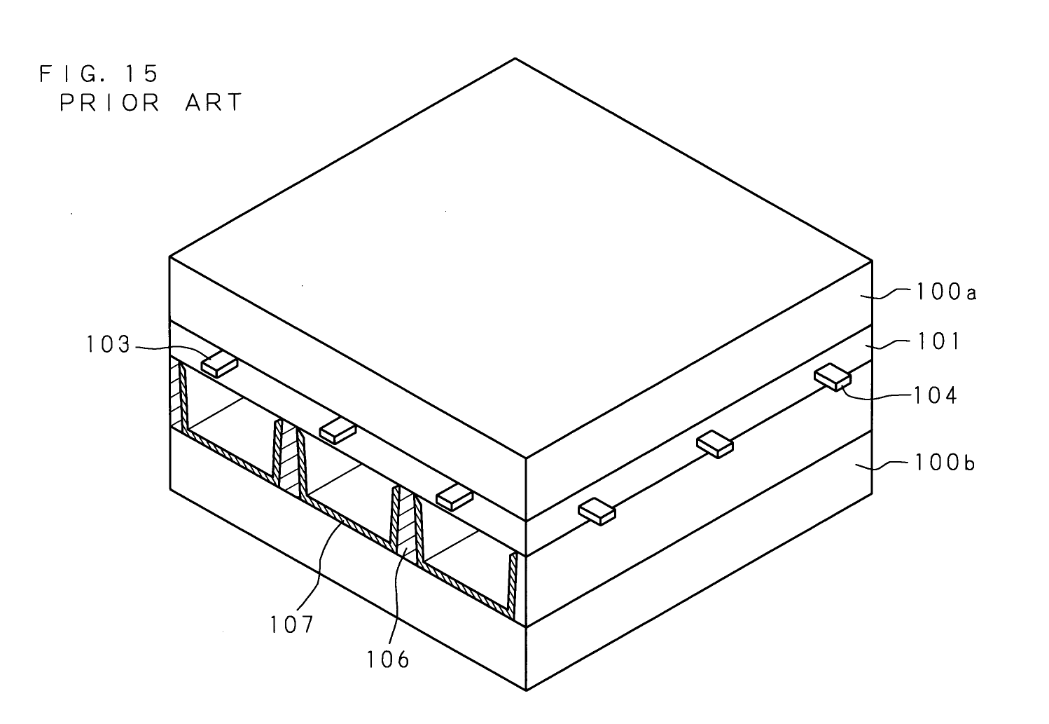

FIG. 16 is a schematic plan view of the conventional discharge display device;

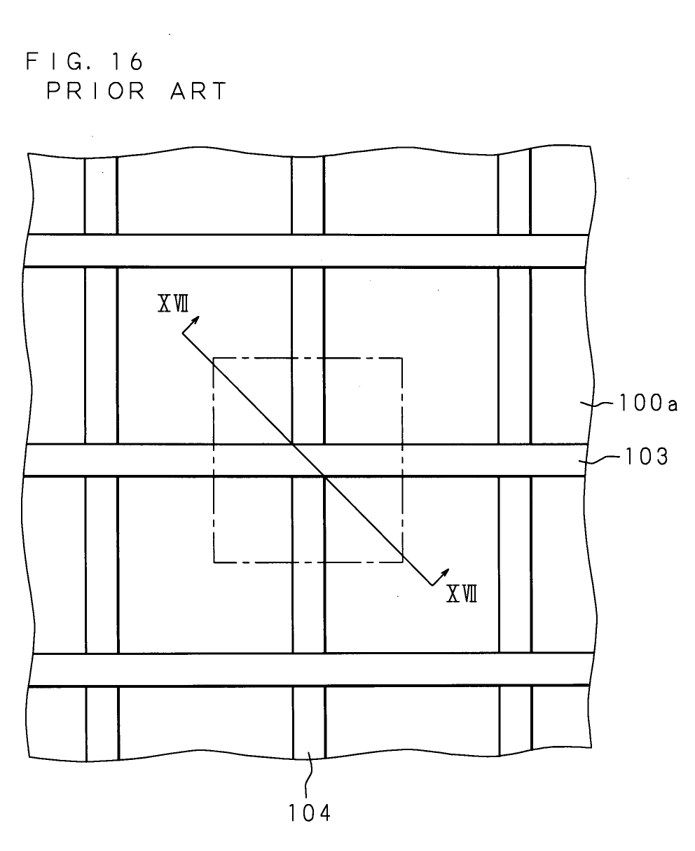

FIG. 17 is a structural sectional view taken along line XVII-XVII of FIG. 16;

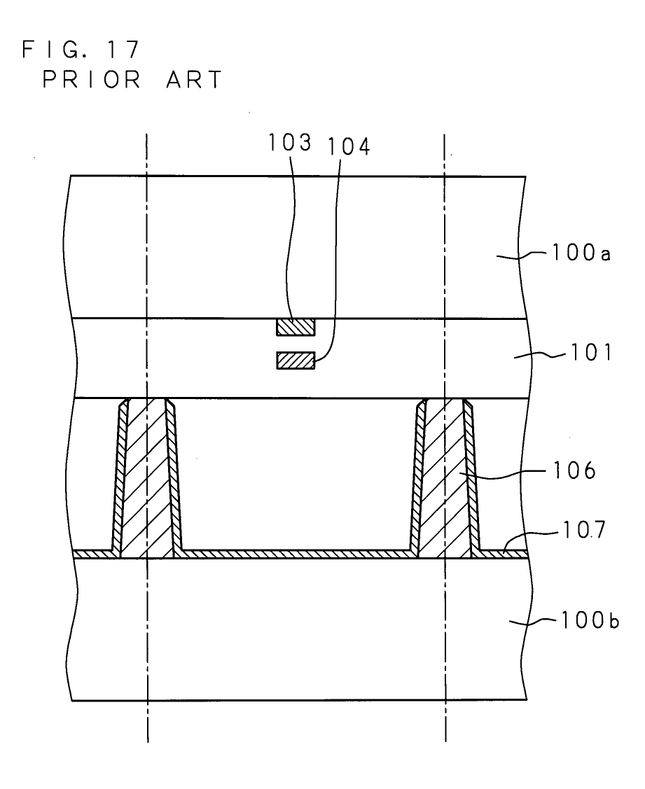

FIG. 18 is a sectional view showing the electric field distribution caused in the discharge space of the conventional discharge display device; and

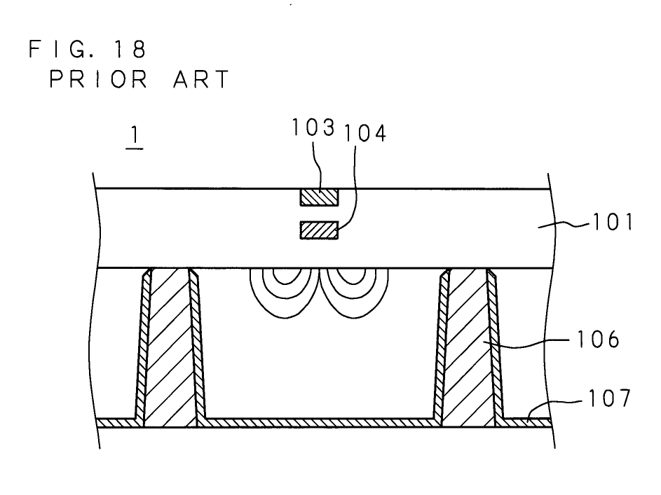

FIG. 19 is a schematic perspective view showing the discharge condition of the conventional discharge display device.

### DESCRIPTION OF THE NUMERALS

1, 2, 3, 4 discharge display device

10a front substrate

10b rear substrate

11, 21, 22, 31, 32, 41, 42 dielectric layer

13, 23, 33, 43 first electrode

14, 24, 34, 44 second electrode

16 partition

17 fluorescent layer

### Best Modes for Implementing the Invention

The present invention will be described in detail based on the drawings showing embodiments thereof.

### First Embodiment

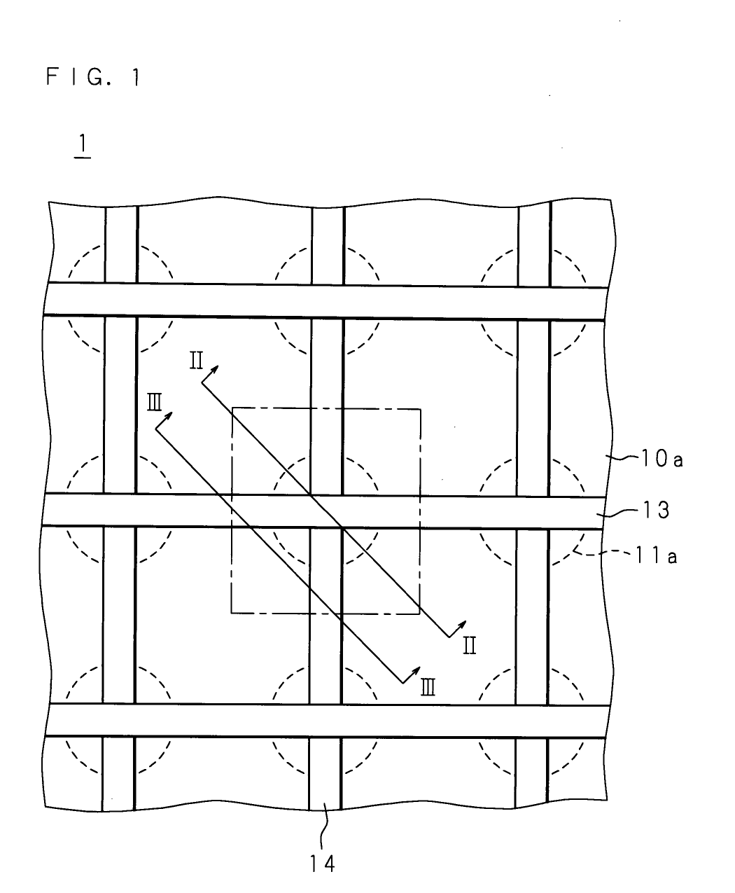

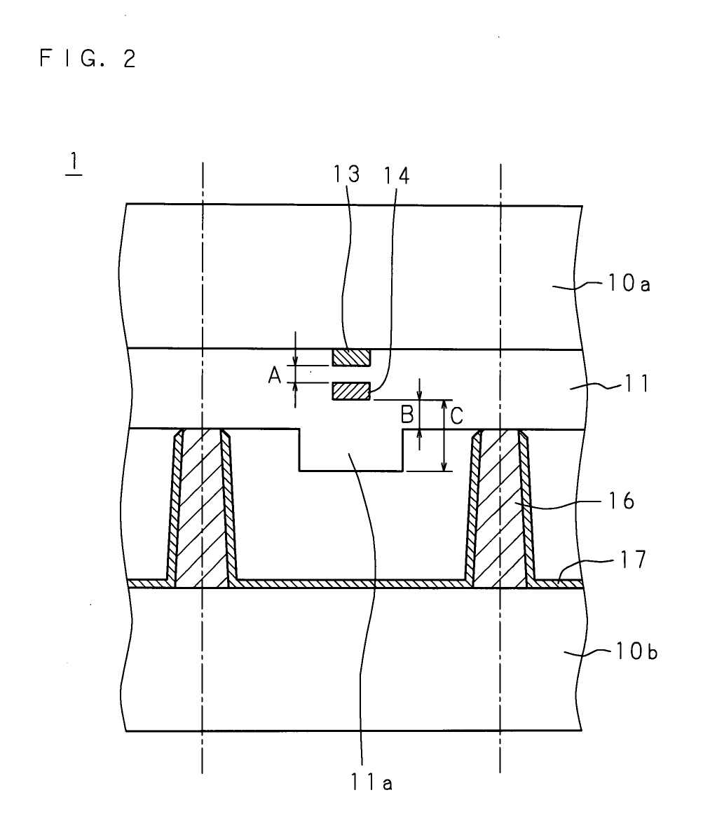

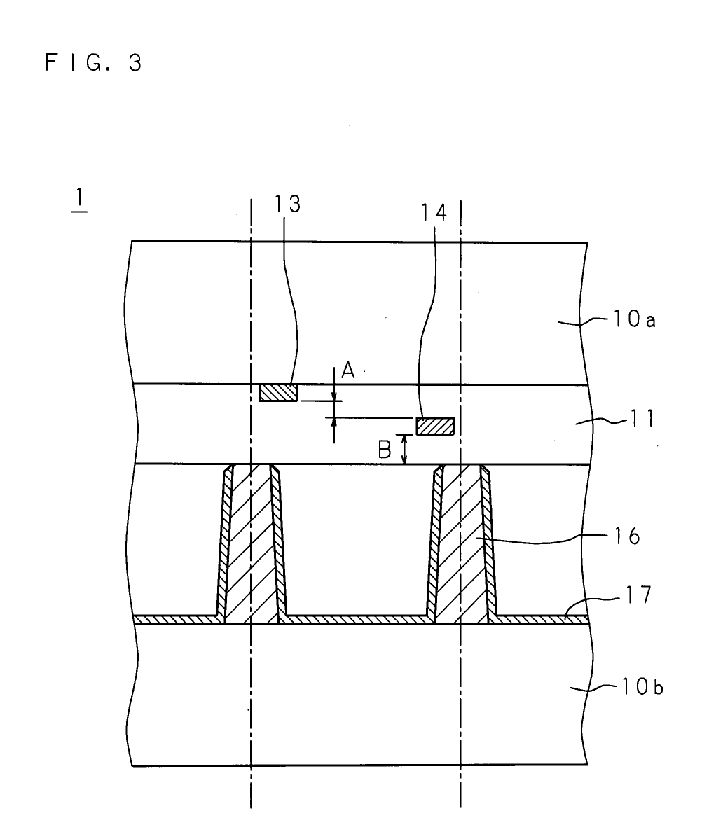

FIG. 1 is a schematic plan view showing a discharge display device according to a first embodiment of the present invention. FIG. 2 is a structural sectional view taken along line II-II of FIG. 1. FIG. 3 is a structural sectional view taken along line III-III of FIG. 1.

The discharge display device 1 according to the first embodiment of the present invention has a structure in which a front substrate 10a and a rear substrate 10b such as glass plates excellent in the transmittance in the visible region are disposed opposite to each other and a discharge medium such as Xe—Ne or Xe—He is sealed in a space (discharge space) formed by sealing the peripheries of the opposing surfaces of the front substrate 10a and the rear substrate 10b with a sealer such as a low-melting-point glass paste.

On the front substrate 10a, a dielectric layer 11 for accumulating the wall charge is formed, and inside the dielectric layer 11, a first electrode 13 and a second electrode 14 orthogonal to each other are formed with a predetermined pitch. Discharge cells (indicated by the alternate long and short dash line) are formed with the intersections of the first electrode 13 and the second electrode 14 at the center. On the rear substrate 10b, a grid-shaped partition 16 with the intersection of the first electrode 13 and the second electrode 14 at the center of each cell is formed, and on the wall surface and the bottom surface of the partition 16, fluorescent layers 17 of three colors of red, green and blue for color display are cyclically formed. The dielectric layer 11 may be covered with a non-illustrated protective coat such as MgO to prevent ion collision with the dielectric layer 11.

The dielectric layer 11 is not flat but is convex 11a at the intersections of the first electrode 13 and the second electrode 14, and the thickness C in the direction of the discharge space from the discharge space side electrode (the electrode 14 in this embodiment) of the first electrode 13 and the second electrode 14 at the intersections is larger than the thickness B of the remaining area (C>B). As described above, in the present invention, the thickness of the dielectric layer 11 in the areas corresponding to the intersections of the first electrode 13 and the second electrode 14 is larger than that in the remaining area.

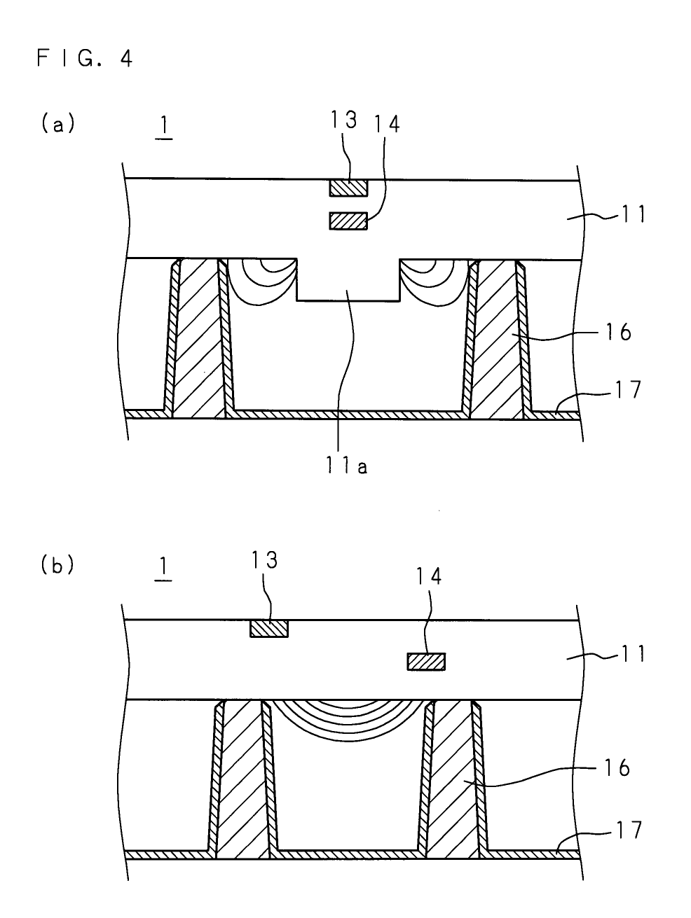

FIG. 4 is sectional views each showing an electric field distribution caused in the discharge space of the discharge display device according to the first embodiment of the present invention.

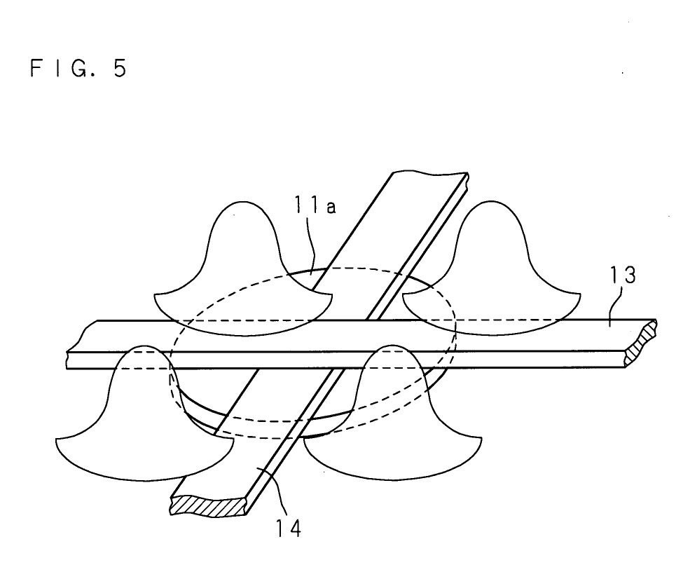

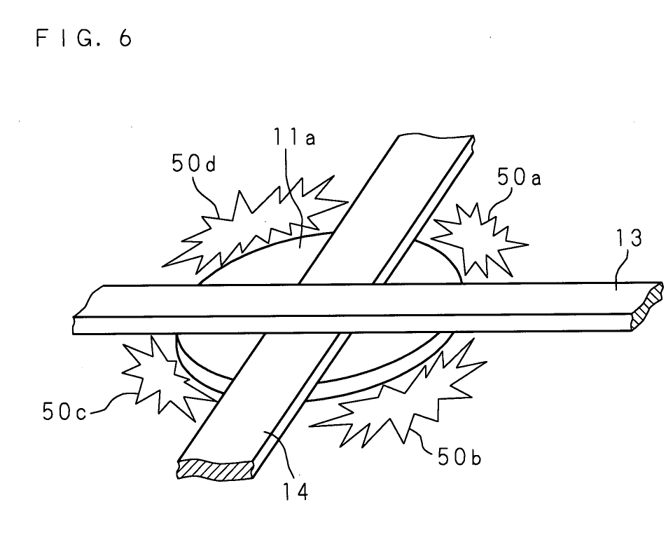

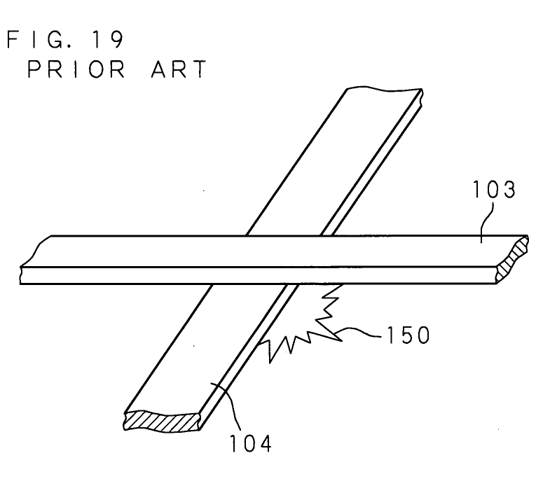

In the discharge display device 1 according to the first embodiment of the present invention, since the thickness of the dielectric layer 11 in the areas corresponding to the intersections of the first electrode 13 and the second electrode 14 is larger than that in the remaining area, the electric field distribution (FIG. 4(a)) at the intersections is coarser than that (FIG. 4(b)) at places apart from the intersections. Consequently, no discharge occurs in the discharge space corresponding to the intersections, and discharge occurs at places apart from the intersections. That is, as shown in FIG. 5, in the discharge display device 1, the electric field is large in four positions around the convex part at the intersection. Therefore, as shown in FIG. 6, discharges 50a, 50b, 50c and 50d occur in these four positions. While discharge occurs only in one position at the intersection in the conventional discharge display device (see FIG. 19), in the discharge display device 1 of the present invention, since discharge occurs in four positions, the luminous efficiency per discharge cell is improved.

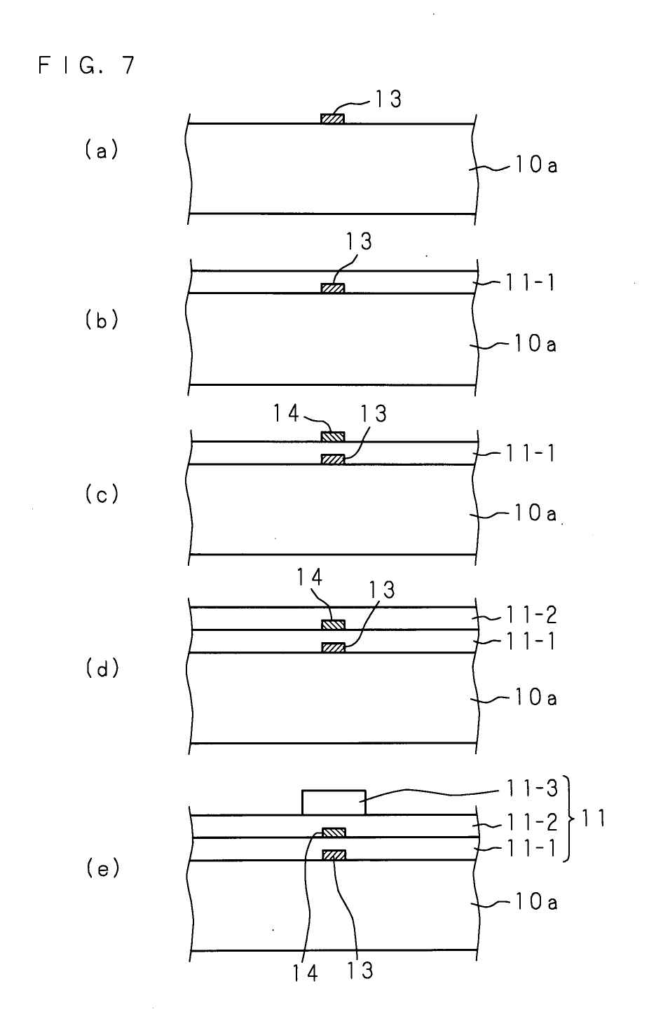

FIG. 7 is explanatory views showing a method for manufacturing the front substrate used for the discharge display device according to the present invention. First, the first electrode 13 is formed in stripes on the front substrate (glass plate) 10a excellent in the transmittance in the visible region (FIG. 7(a)). It is desirable that the first electrode 13 be a transparent electrode such as an ITO electrode or a NESA electrode in order that emitted light can be efficiently taken out from the front substrate 10a. When the sheet resistance of the first electrode 13 is higher than a desired value, a metal electrode with high conductivity is formed to thereby reduce the line resistance so that the intensity of the discharge light is uniform over the entire display area. It is desirable to suppress brightness nonuniformity and ensure excellent color reproducibility in this manner. It is to be noted that it is desirable for the line width in the display area to be a minimum width which is not more than the required resistance because the metal electrode is low in light transmittance. Further, a metal electrode and a transparent electrode wider than the metal electrode may be placed one on another.

Then, a dielectric layer 11-1 is formed on one surface to cover the first electrode 13 by the screen printing method which itself is known (FIG. 7(b)). For example, the dielectric layer 11-1 is formed by applying a paste of a vehicle containing an ethyl cellulose resin as the main ingredient and in which low-melting-point glass powder (frit) is dispersed, and firing the resin component. Then, the second electrode 14 is formed in stripes on the dielectric layer 11-1 (FIG. 7(c)), and a dielectric layer 11-2 is formed on one surface to cover the second electrode 14 (FIG. 7(d)). Although in FIG. 7 showing the cross sections taken along line II-II of FIG. 1, the first electrode 13 and the second electrode 14 appear to extend in the same direction, the first electrode 13 and the second electrode 14 extend in directions orthogonal to each other.

Then, a dielectric layer 11-3 is formed through a printing plate of a pattern where the areas corresponding to the intersections are opened (FIG. 7(e)). The dielectric layer 11 where the parts of the intersections of the first electrode 13 and the second electrode 14 are convex can be formed in this manner. The dielectric layers 11-1, 11-2 and 11-3 may be formed by a chemical vapor deposition method such as the plasma CVD method. With the chemical vapor deposition method, since the dielectric layer can be formed so that its thickness is highly precise and uniform with stability and throughput is improved, cost can be reduced in large-scale mass production. However, when the dielectric layer 11-3 is formed, it is necessary to perform etching so that the dielectric layer 11-3 remains, after the dielectric material formed into the dielectric layer is applied to substantially one surface.

Next, it is evaluated how the position where discharge occurs changes according to the distance A between the first electrode 13 and the second electrode 14, the thickness B in the direction of the discharge space from the second electrode 14 at the intersections, and the thickness C in the remaining area (see FIG. 2). It is recognized that when A:B:(C−B)=1:1:1, the discharge path is formed in the dielectric layer increased in thickness although the discharge positions can be slightly displaced from the intersections. On the other hand, it is recognized that when A:B:(C−B)=1:1:2, the discharge positions can be significantly displaced from the intersections and the discharge path is formed around the convex parts at the intersections. Therefore, it is desirable that the thickness of the dielectric layer in the corresponding areas be not less than twice that in the remaining area, that is, (C−B)/B≧2, and if (C−B)/B≧3, discharge can be caused in four positions around the intersections. It is also recognized that although the discharge voltage is higher than that in the conventional device since the discharge distance between the first electrode 13 and the second electrode 14 is long (called long-distance discharge), the luminous efficiency is improved by performing long-distance discharge.

The purport of the present invention is that by increasing the thickness of the dielectric layer at the intersection, the occurrence of discharge at the intersection is avoided and long-distance discharge is caused in positions apart from the intersection to thereby improve the luminous efficiency per discharge cell. The positions where discharge occurs can be controlled, for example, by adjusting the thickness and/or the area of the dielectric layer to thereby appropriately adjust the electric field distribution caused in the discharge cells, and light can be efficiently emitted from the discharge cells by controlling the position where discharge occurs. Therefore, for example, when the size of the discharge cells is increased in order to increase the screen size, light can be efficiently emitted from the entire area of the discharge cells by displacing the position where discharge occurs from the intersection of the electrodes and causing discharge in four positions around the intersection.

### Second Embodiment

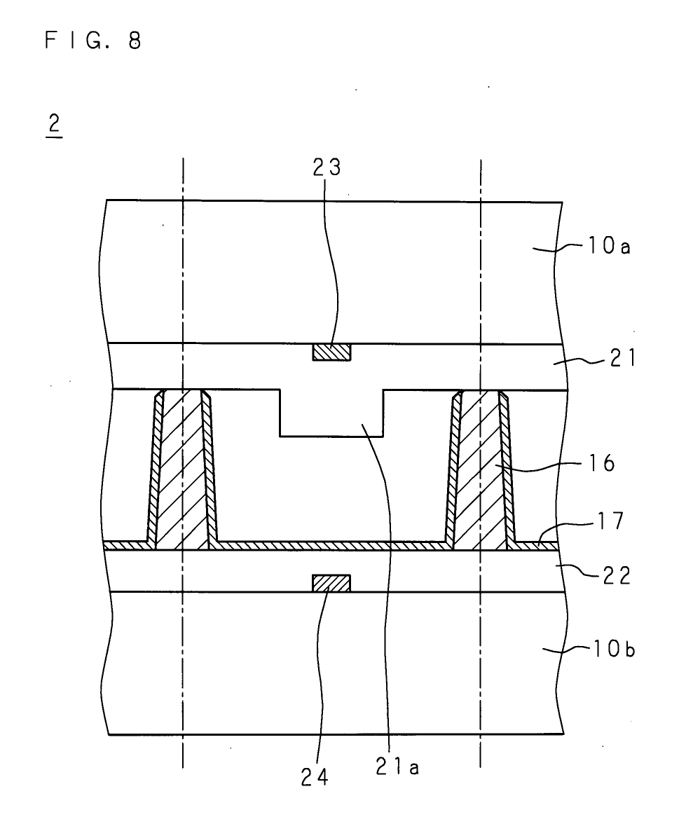

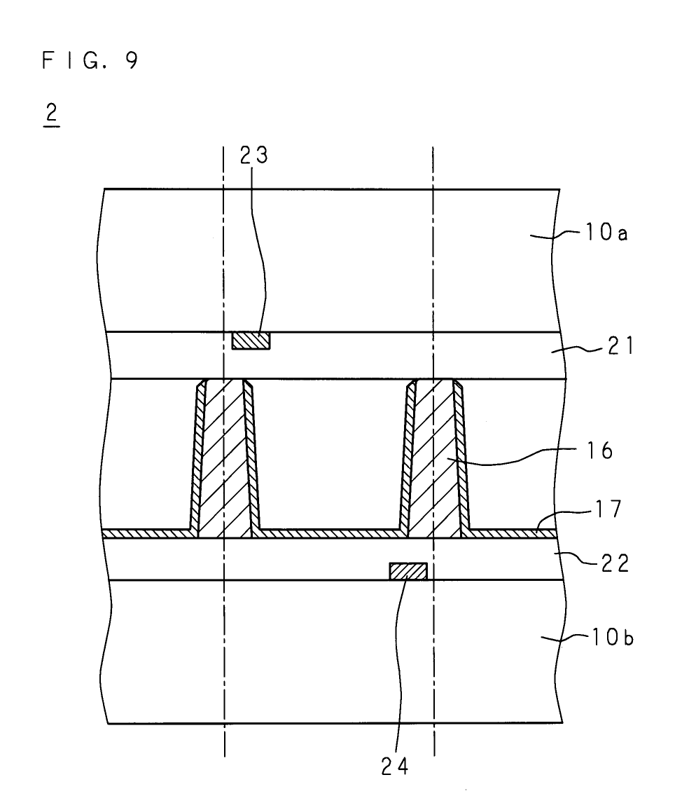

While the discharge display device in which the first electrode and the second electrode for causing the sustaining discharge are provided on one substrate (front substrate) is described in the first embodiment, it is not always necessary that the first electrode and the second electrode be provided on the same substrate, and a discharge display device having such a structure is a second embodiment. FIGS. 8 and 9 are structural sectional views of the discharge display device according to the second embodiment of the present invention, and a plan view thereof is not shown because it is similar to FIG. 1. FIG. 8 corresponds to the structural sectional view taken along line II-II of FIG. 1. FIG. 9 corresponds to the structural sectional view taken along line III-III of FIG. 1.

On the front substrate 10a, a dielectric layer 21 for accumulating the wall charge is formed, and inside the dielectric layer 21, a first electrode 23 is formed with a predetermined pitch. On the rear substrate 10b, a dielectric layer 22 is formed, and inside the dielectric layer 22, a second electrode 24 orthogonal to the first electrode 23 is formed with a predetermined pitch. The grid-shaped partition 16 with the intersection of the first electrode 23 and the second electrode 24 at the center of each cell is formed, and the fluorescent layers 17 of three colors of red, green and blue for color display are cyclically formed on the wall surface and the bottom surface of the partition 16.

The dielectric layer 21 is not flat but is convex 21a at the intersections of the first electrode 23 and the second electrode 24, and because of the convex dielectric layer 21, the thickness on the discharge space side in the corresponding areas is larger than that in the remaining area. As described above, in the discharge display device 2 according to the second embodiment of the present invention, since the thickness of the dielectric layer 21 in the areas corresponding to the intersections of the first electrode 23 and the second electrode 24 is larger than that in the remaining area, the electric field distribution at the intersections is coarser than that at places apart from the intersections, so that discharge occurs not at the intersections but at places apart from the intersections. That is, since discharge occurs in four positions around the convex part at the intersection, the luminous efficiency per discharge cell is improved.

### Third Embodiment

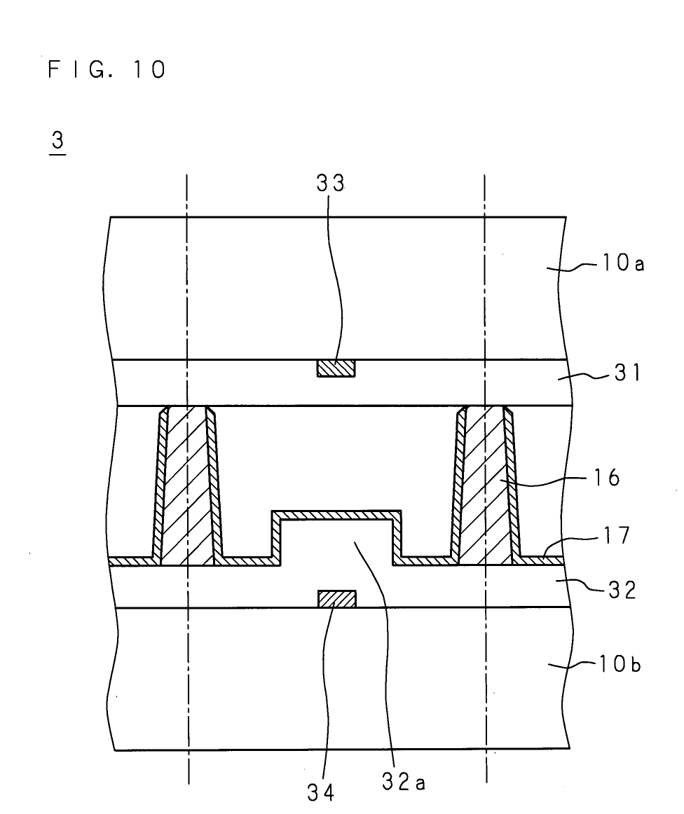

While the discharge display device in which the thickness, on the discharge space side, of the dielectric layer on the front substrate side is larger than that in the remaining area is described in the second embodiment, the thickness, on the discharge space side, of the dielectric layer on the rear substrate side may be larger than that in the remaining area, and a discharge display device having such a structure is a third embodiment. FIG. 10 is a structural sectional view of the discharge display device according to the third embodiment of the present invention, and a plan view thereof is not shown because it is similar to FIG. 1. FIG. 10 corresponds to the structural sectional view taken along line II-II of FIG. 1.

On the front substrate 10a, a dielectric layer 31 for accumulating the wall charge is formed, and inside the dielectric layer 31, a first electrode 33 is formed with a predetermined pitch. On the rear substrate 10b, a dielectric layer 32 is formed, and inside the dielectric layer 32, a second electrode 34 orthogonal to the first electrode 33 is formed with a predetermined pitch. The grid-shaped partition 16 with the intersection of the first electrode 33 and the second electrode 34 at the center of each cell is formed, and the fluorescent layers 17 of three colors of red, green and blue for color display are cyclically formed on the wall surface and the bottom surface of the partition 16.

The dielectric layer 32 is not flat but is convex 32a at the intersections of the first electrode 33 and the second electrode 34, and because of the convex dielectric layer 32, the thickness on the discharge space side in the corresponding areas is larger than that in the remaining area. As described above, in the discharge display device 3 according to the third embodiment of the present invention, since the thickness of the dielectric layer 32 in the areas corresponding to the intersections of the first electrode 33 and the second electrode 34 is larger than that in the remaining area, the electric field distribution at the intersections is coarser than that at places apart from the intersections, so that discharge occurs not at the intersections but at places apart from the intersections. That is, since discharge occurs in four positions around the convex part at the intersection, the luminous efficiency per discharge cell is improved.

### Fourth Embodiment

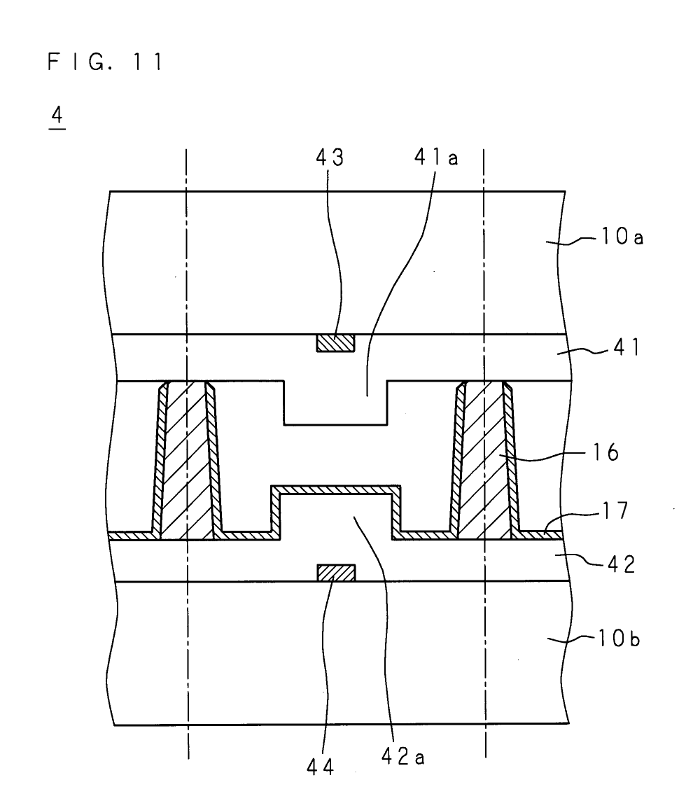

While the discharge display devices in which the thickness, on the discharge space side, of the dielectric layer on one substrate side is larger than that in the remaining area are described in the second and third embodiments, the thicknesses, on the discharge space side, of the dielectric layers on the front and rear substrate sides may be larger than those in the remaining area, and a discharge display device having such a structure is a fourth embodiment. FIG. 11 is a structural sectional view of the discharge display device according to the fourth embodiment of the present invention, and a plan view is not shown because it is similar to FIG. 1. FIG. 11 corresponds to the structural sectional view taken along line II-II of FIG. 1.

On the front substrate 10a, a dielectric layer 41 for accumulating the wall charge is formed, and inside the dielectric layer 41, a first electrode 43 is formed with a predetermined pitch. On the rear substrate 10b, a dielectric layer 42 is formed, and inside the dielectric layer 42, a second electrode 44 orthogonal to the first electrode 43 is formed with a predetermined pitch. The grid-shaped partition 16 with the intersection of the first electrode 43 and the second electrode 44 at the center of each cell is formed, and the fluorescent layers 17 of three colors of red, green and blue for color display are cyclically formed on the wall surface and the bottom surface of the partition 16.

The dielectric layers 41 and 42 are not flat but are convex 41a and 42a at the intersections of the first electrode 43 and the second electrode 44, and because of the convex dielectric layers 41 and 42, the thicknesses on the discharge space side in the corresponding areas are larger than those in the remaining area. As described above, in the discharge display device 4 according to the fourth embodiment of the present invention, since the thicknesses of the dielectric layers 41 and 42 in the areas corresponding to the intersections of the first electrode 43 and the second electrode 44 are larger than those in the remaining area, the electric field distribution at the intersections is coarser than that at places apart from the intersections, so that discharge occurs not at the intersections but at places apart from the intersections. That is, since discharge occurs in four positions around the convex part at the intersection, the luminous efficiency per discharge cell is improved.

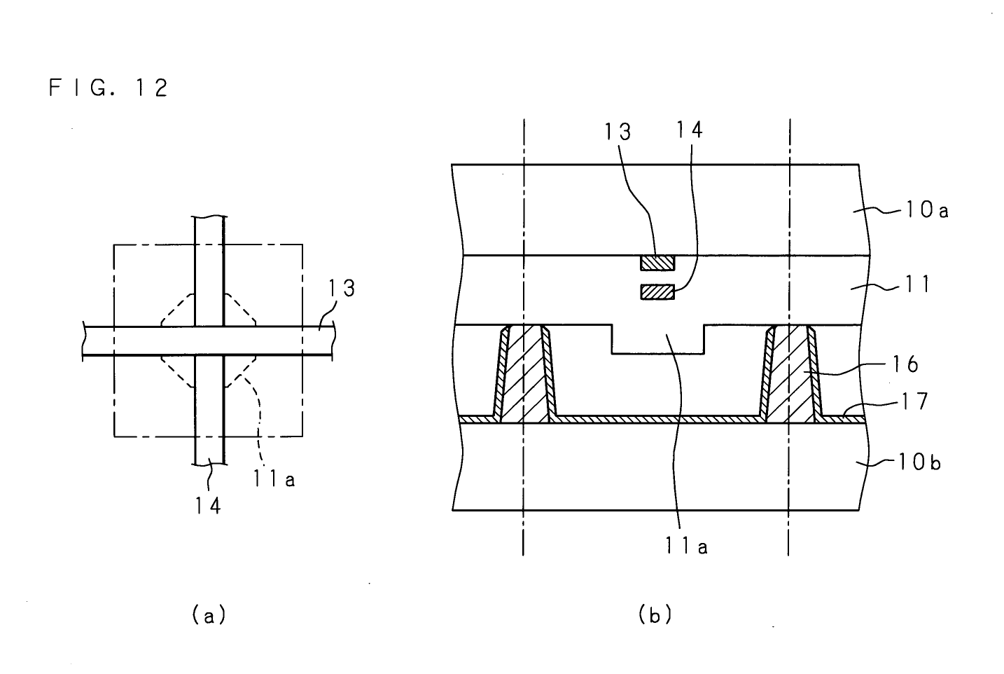

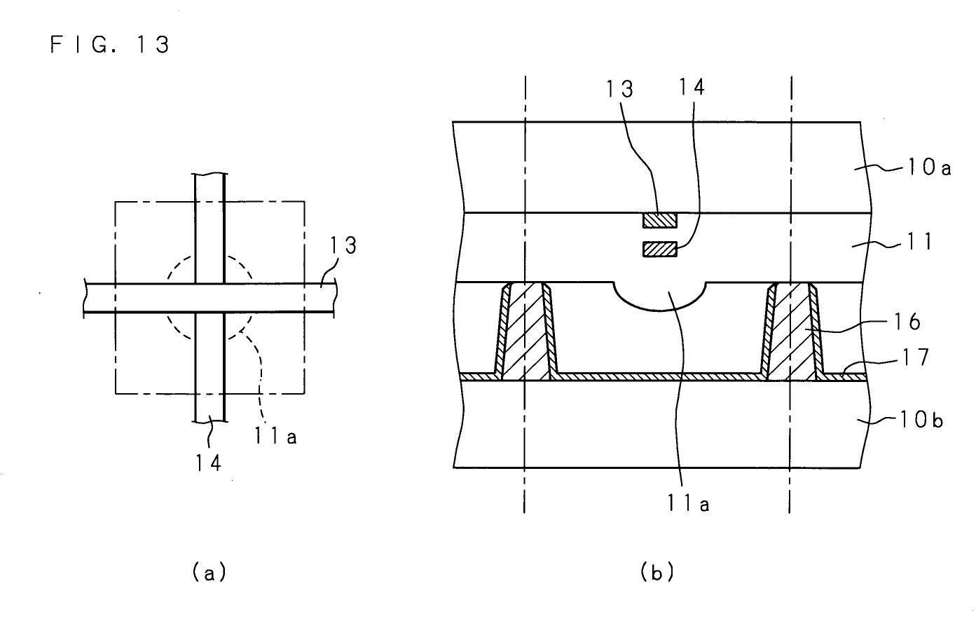

While the part of the dielectric layer having the different thickness is circular when viewed as a plan view and rectangular in cross section, that is, is cylindrical is described in each embodiment, the part of the dielectric layer may be polygonal when viewed as a plan view (octagonal in FIG. 12(a)) and rectangular in cross section (FIG. 12(b)) as shown in FIG. 12 or may be circular when viewed as a plan view (FIG. 13(a)) and arc-shaped in cross section (FIG. 13(b)) as shown in FIG. 13; thus, the configuration of the part of the dielectric layer is not specifically limited. By appropriately adjusting the thickness and/or the area of the dielectric layer, setting can be made so that discharge occurs in a desired position.

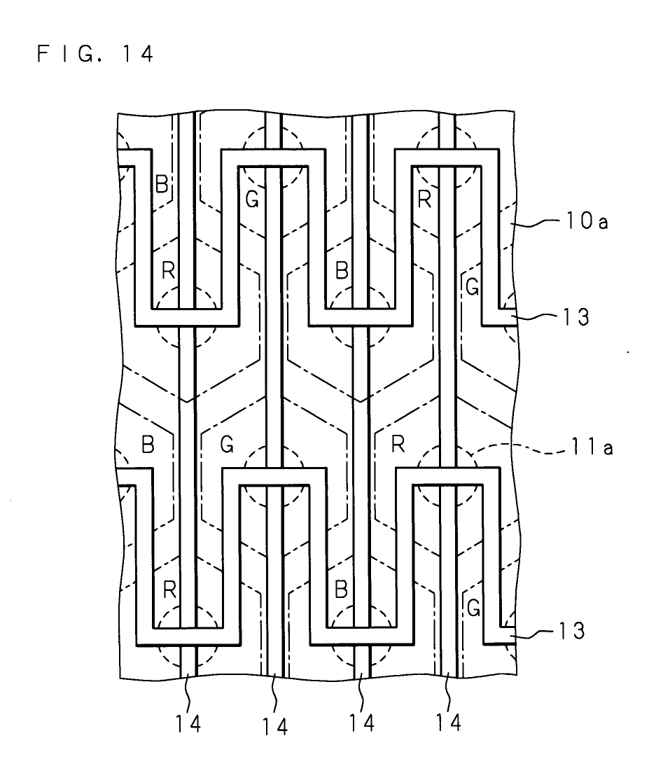

While the discharge cells are formed in a matrix form by the partition being grid-shaped, the partition may be undulated so that the discharge cells are formed in a honeycomb form (delta form) as shown in FIG. 14. In this case, the first electrode 13 is arranged not linearly but undulately so that the first electrode and the second electrode intersect each other at the center of each discharge cell. It is unnecessary that the discharge cells be completely demarcated by the partition, and a stripe structure in which the partition is formed in a stripe form may be employed. However, in the present invention, since the areas where discharge occurs are displaced from the centers of the discharge cells and this can cause color mixture between adjoining cells, it is desirable that the discharge cells be completely demarcated by the partition.

While the address discharge and the sustaining discharge of each discharge cell are controlled by one first electrode and second electrode, the address discharge may be performed by another electrode, or the first electrode and/or the second electrode may consist of a group of a plurality of electrodes. The present invention is applicable to discharge display devices in which a pair of electrodes (electrode groups) for the sustaining discharge intersect each other.

1-5. (canceled)

6. A discharge display device, comprising:
two substrates opposite to each other;
a discharge medium sealed between the two substrates to form a discharge space;
a dielectric layer; and
a first electrode and a second electrode intersecting each other;
wherein by applying a voltage between the first electrode and the second electrode, an electric field distribution is caused in the discharge space through the dielectric layer to thereby sustain discharge; and
a thickness, on a discharge space side, of the dielectric layer in an area corresponding to an intersection of the first electrode and the second electrode is larger than a thickness in a remaining area.

7. The discharge display device according to claim 6,
wherein the electric field distribution caused in the discharge space is adjusted by adjusting the thickness of the dielectric layer in the area corresponding to the intersection.

8. The discharge display device according to claim 7,
wherein a thickness of the dielectric layer in the corresponding area is not less than twice a thickness in a remaining area.

9. The discharge display device according to claim 7,
wherein the electric field distribution caused in the discharge space is adjusted by adjusting an area of the dielectric layer in the corresponding area.

10. The discharge display device according to claim 9,
wherein a thickness of the dielectric layer in the corresponding area is not less than twice a thickness in a remaining area.

11. A discharge display device, comprising:
two substrates opposite to each other;
a discharge medium sealed between the two substrates to form a discharge space;
a dielectric layer provided on one of the two substrates; and
a first electrode and a second electrode intersecting each other inside the dielectric layer;
wherein by applying a voltage between the first electrode and the second electrode, an electric field distribution is caused in the discharge space through the dielectric layer to thereby sustain discharge; and
a thickness of the dielectric layer in a direction of the discharge space from a discharge space side electrode of the first electrode and the second electrode in an area corresponding to an intersection of the first electrode and the second electrode is larger than a thickness in a remaining area.

12. The discharge display device according to claim 11,
wherein the electric field distribution caused in the discharge space is adjusted by adjusting the thickness of the dielectric layer in the area corresponding to the intersection.

13. The discharge display device according to claim 12,
wherein a thickness of the dielectric layer in the corresponding area is not less than twice a thickness in a remaining area.

14. The discharge display device according to claim 12,
wherein the electric field distribution caused in the discharge space is adjusted by adjusting an area of the dielectric layer in the corresponding area.

15. The discharge display device according to claim 14,
wherein a thickness of the dielectric layer in the corresponding area is not less than twice a thickness in a remaining area.
